(19) United States
(12) Patent Application Publication
(10) Pub. No.: US 2005/0061606 A1
(43) Pub. Date: Mar. 24, 2005

(54) Method and apparatus for transfering coin/token signature data between coin/token acceptor devices

(76) Inventor: Scott Juds, Seattle, WA (US)

Correspondence Address: Vincent L. Ramik;DILLER, RAMIK & WIGHT, Suite 101, 7345 McWhorter Place, Annandale, VA, 22003, US

(21) Appl. No.: 10/655,063

(22) Filed: Sep. 5, 2003

(51) Int. Cl. G07D 7/00

(52) U.S. Cl. 194/302

(57) ABSTRACT

The reference frame of production coin acceptors are calibrated with a set of reference objects so that their individual reference frames may be mapped from one to another to facilitate the transfer of coin signature data from one coin acceptor to another. Individual differences due to component variation are transformed out such that the windows of acceptance for each of the coin signature sensor readings may be as tight as possible to achieve both high acceptance of good coins and high security against unwanted coins.

### FIELD OF THE INVENTION

This invention relates to a coin acceptor and is particularly concerned with the transfer of standardized coin signature data to and from the coin acceptor to facilitate rapid configuration of multiple acceptors.

### BACKGROUND OF THE INVENTION

Coin acceptors have long been known to function well with both currency coinage issued by governments and token coinage issued by business establishments. From the perspective of the coin acceptor, both are substantially circular metallic discs having a particular diameter, thickness and metal alloy content. As such, the term coin herein will be used in its broader meaning to include that of both coins issued as currency and as tokens.

Programmable coin acceptors which hold coin signature data in memory have been well known at least since the grant of U.S. Pat. No. 3,918,565 on Nov. 11, 1975 to Fougere et al. Coin signature data is typically acquired and programmed into the coin acceptor's memory through either a) passing samples of the coins through the acceptor in a learning mode of operation to generate the coin signature data as described in U.S. Pat. No. 4,556,140 granted on Dec. 3, 1985 to Okada, or b) through a means of downloading standardized coin signature data into the coin acceptor from an external database as described in GB 2,182,477 granted May 13, 1987 to Knabbe.

The coin signature date generally takes the form of defined windows of acceptance for the data produced by each of the sensors in the coin acceptor. The need for acceptance windows for each of the sensor data relates to the physical property variation from coin-to-coin, and the variation in the presentation position from one coin to the next. The sensors may include inductive metal sensors, optical diameter sensors, optical surface sensors, ultrasonic thickness sensors, or other such sensors which produce data dependant on the physical characteristics of the coin. In normal operation, a coin passes through the coin acceptor past each of the sensor stations where data is produced for comparison with the pre-defined windows of acceptance such that if the coin is found to be acceptable, an accept gate is opened to direct the coin to an accept path. Otherwise, the accept gate remains closed and the coin is directed to a reject path.

The width of the acceptance windows is a compromise between a number of factors. The acceptance window widths should be made as narrow as possible to achieve satisfactory discrimination between valid and invalid coins. However, if the windows are made too narrow, there is a risk that valid coins will be rejected as a result of small variations from one coin to the next.

An additional problem created by minor component variations that occur in the manufacture of acceptors of the same design is that it is not possible to program a fixed set of acceptance window data into mass produced coin acceptors of the same design. Without a means to adjust for production variations, simply downloading standard coin signature data into the coin acceptor device as taught in Knabbe Pat. No. GB 2,182,477 results in the need to have excessively wide acceptance windows, not only to accommodate coin variation, but also to accommodate coin acceptor component variation. Hence the discrimination performance of such mass produced coin acceptors would not be as good as coin acceptors individually programmed with coin samples according to the teachings of Okada U.S. Pat. No. 4,556,140 granted on Dec. 3, 1985.

In order to achieve the dual goals of a) having excellent discrimination through tight acceptance windows, and b) allowing the simplicity and accuracy of downloadable coin signatures, two solutions have emerged. First, in EP 0072189 granted Feb. 16, 1983 to Daw a of a dissimilar pair of reference calibration coins, both of which are programmed into the coin acceptor by passing samples of the coins through the acceptor in a learning mode of operation to generate the coin signature data, which are then compared to standardized values for the reference coins and is used to generate offset and scale factor coefficients for use by the coin acceptor to adjust downloaded coin signature data for the manufacturing variations present in the specific coin acceptor. Second, in U.S. Pat. No. 6,230,869 granted May 15, 2001 to Barson there is disclosed a method of progressive dragging and shrinking of the acceptance windows in normal operation subsequent to coin signature download such that an initial wider tolerance set of data can accommodate manufacturing tolerances while the dragging and shrinking of the acceptance windows soon achieves the optimum discriminating characteristics.

Although the means and methods of the prior art have done well to address the need to download accurate coin signature data to coin acceptors in the mass production environment of the factory or massive field installations, such as are found in large casinos, there still remains one important circumstance in which the prior art fails to provide a functional solution. It is well known to those dealing with field installations that the number of different coins from all the world's countries, and all the different tokens stamped out by private mints, seem endless, thus making it nearly impossible to do even a reasonably complete job of filling the database with all of the possible coin signatures for coins a customer may decide to use. The solutions, as they exist, would require a casino wanting to use a new coin or token in a few hundred slot machines to hand program each coin acceptor by passing the requisite sample coins or tokens through each coin acceptor in its learning mode of operation, or uninstall and send the coin acceptors back to the factory with samples of the new coin or token so that its coin signature may be added to the database and then downloaded into each of the coin acceptors. Even if a portable programmer exists in the field for this purpose, the coins must still be characterized and added to the database at the factory, then the portable programmer's database must be updated from the factory master database, and then each of the coin acceptors may be updated by downloading the new coin signature.

As can readily be appreciated from the preceding description, there is a need to simplify the process of obtaining coin signature data for new coin types in the field so that both end user and OEM customers can go on with their business of programming batches of coin acceptors for the new coin without the need to involve the coin acceptor manufacturer and wait in its development and delivery queues for the new coin signatures.

### SUMMARY OF THE INVENTION

The present invention relates to a method of and apparatus for use primarily by field personnel to transfer coin signature data from a first coin acceptor to one or more other coin acceptors of the same production model such that each operates and accepts coins in the same manner.

A first aspect of the invention recognizes that in the mass production of a coin acceptor there are slight variations in components from unit to unit. Such variation consequently results in slight variations in the measurements made by the sensors of each unit. In order to calibrate out the differences between different production units, one of the production units is designated as the reference standard unit and is used for the generation of coin signature data. The coin signature data for each coin of interest is stored in a database for the purpose of possible future download to other of the production units.

A second aspect of the invention recognizes that each of the sensors in the array of sensors that are part of the coin acceptor produces a range of values, and that the differences in this range of values from one production unit to another can be linearly corrected through use of a calibration offset and scale factor. The standard coin signature data can then be transformed with these offsets and scale factors from values meaningful for the reference standard unit to values meaningful for the production unit associated with these offsets and scale factors.

A third aspect of the invention is that the offsets and scale factors for each production unit may be generated by using a set of reference coins that produce both a high and a low calibration reference point within the range of values produced by each of the sensors in the array of sensors. The offsets and scale factors are computed using simple linear algebra to compute the coefficients m and b in the equation x′=mx+b from the calibration reference points for the particular production unit and the calibration reference points for the reference standard unit which are also known to it.

The fourth aspect of the invention is that any production unit that has been calibrated with the reference coins and has calibration offsets and scale factors for each of the sensors can be used to generate the standard coin signature data for a coin by doing the reverse transform x=(x′−b)/m on each of the coin signature data values.

The fifth aspect of the invention is utilizing temperature information to further compensate the aforementioned transforms of coin signature data such that data taken at one temperature and used at another temperature are properly compensated. The individual data are compensated according to an equation of the form x′=δT(ax+b) where δT is the difference in temperature between the present and the time when the reference coin values were recorded and coefficients a and b respectively determine the linear and fixed offset compensation proportional to the temperature differential.

Another aspect of the invention is utilizing an intermediary device for communication with coin acceptors, the device having the capability to both download standard coin signature data to the coin acceptor and upload standard coin signature data from the coin acceptor. The communication device has the ability to perform a “copy and clone” procedure wherein coin signature data is first uploaded from a first coin acceptor that has been manually programmed to accept one or more coins, then downloaded to one or more other coin acceptor units of the same model. Coin signature data is transformed using acceptor specific component and temperature calibration values, either in the coin acceptors or in the coin signature transfer device, from the reference frame of the first coin acceptor to the reference frame of the respective other coin acceptors.

With the above and other objects in view that will hereinafter appear, the nature of the invention will be more clearly understood by reference to the following detailed description, the appended claims and the several views illustrated in the accompanying drawings.

### BRIEF DESCRIPTION OF THE DRAWINGS

FIG. 1 is a diagramatic perspective view, and illustrates a coin acceptor with coin entry and exit locations and having a connection to a portable device for both upload and download transferring of coin signature data.

FIG. 2 is a graph and illustrates the transformation of standard coin signature values into coin signature values for a specific coin acceptor in accordance with Table 1 data and description infra.

FIG. 3 is a representative prior art resonant circuit for generating a damped sinusoid responsive to the presence of a coin.

FIG. 4a shows the characteristic response of a resonant circuit with no coin near the detection coil.

FIG. 4b shows the response of the resonant circuit with a coin near the detection coil.

FIG. 5a is a graph and illustrates the temperature effect on the damped sinusoid with and without coins near the detection coil.

FIG. 5b is a transformation of the data of FIG. 5a in to the same format as that of FIG. 2 having the coin physical properties as the horizontal axis independent variable.

FIG. 6 is a block diagram of components of a coin signature transfer device.

### DETAILED DESCRIPTION OF THE INVENTION

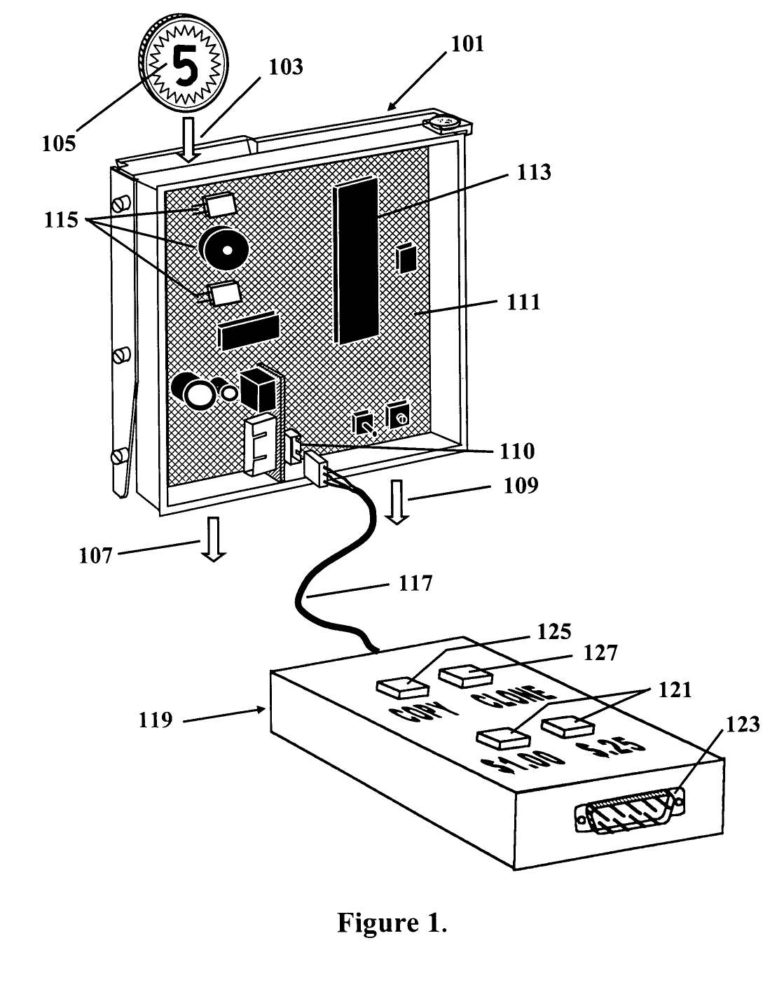

A coin acceptor 101 (FIG. 1) includes a coin chute entry 103 into which a coin 105 is dropped. The coin acceptor 101 is generally mounted within a vending machine, slot machine, pay telephone or other such coin activated device. The coin 105 passes through the coin acceptor 101 to a coin chute exit 107 if the coin 105 is accepted as a valid coin, or to coin chute exit 109 if the coin 105 is rejected as an invalid coin. The coin acceptor 101 controls the coin path via an accept/reject gate (not shown) just above the coin accept path exit 107.

Within the enclosure of the coin acceptor 101 is a circuit board 111 having a microcontroller 113 for acquiring metal alloy, diameter, and other such information about passing coins from a group of inductive, optical, or capacitive sensors 115. The microcontroller 1 13 compares the acquired sensory information against coin signature data for acceptable coins that has previously been programmed into its memory in order to decide whether to accept or reject the coin. The coin signature data is typically in the form of an array of expected numerical values, each having an associated tolerance, and each associated with the output of a particular sensor. Multiple sensors and sensor configurations are generally used in order to ascertain information about distinct physical characteristics of the coin.

To create a coin signature database useful to all mass produced coin acceptors having the same design, a single unit must be chosen and designated as the “standard coin acceptor” and defined as having the “standard reference frame” upon which the coin signature data for all coins in the database will be based. The operating conditions for the standard coin acceptor are controlled so each data taking session provides repeatable results. The coin signature data includes both the expected values, which can be obtained by averaging readings from a large number of coins, and tolerance information, which can also be obtained by finding the maximum and minimum deviation from the average value for the same group of coins. Variations in readings comes from variations in individual coins in circulation, from variations in presentation of the coin to the sensors as it passes through the coin chute, and from variations in the components composing the sensors. In practice, taking data from approximately 50 to 100 coins is quite sufficient to do an excellent job at finding the expected average values and the associated variances. Together these values create what is often referred to as an “acceptance window” for the values derived from each sensor.

Caution must be taken in the selection of the coin set for generating the coin signature data. It is not uncommon for there to be slight differences in the minting from one batch of coins to the next. Furthermore, it is not uncommon for countries or establishments to make wholesale changes in the composition of their coins or tokens to save money or improve security. An excellent example of such wholesale changes is the Canadian coin set where for example, in the past 25 years the composition of pennies and nickels have changed twice, and the composition of dimes, quarters and half dollars have changed once. Since all of these coins are still in circulation, in order for a coin acceptor to properly accept Canadian nickels it must actually have the coin signature for three distinct coins; a) magnetic 99.9% nickel from 1955 to 1981, b) non-magnetic 75% copper, 25% nickel from 1982 to 1999, and c) magnetic 94.5% steel, 3.5% copper, 2% nickel plating starting in year 2000. Because the coin signature for these three Canadian nickels are so divergent from one another, it is imperative that they not be mixed when data is take to determine the averages and variances for the acceptance windows of the coin signature.

Table 1 shows the standard coin signature data for the Canadian $2 coin for the IDX model X-10 coin acceptor indicating the expected values and acceptance tolerance for each of the sensors. Although these data have been defined as the standard coin signature values for this coin with the X-10 coin acceptor, very few other X-10 coin acceptors will read exactly the same values for the Canadian $2 coin. The nature of electronic components includes the fact that there will be variation between the components assembled into each of the production units of the same model, and that temperature will further affect component properties causing possible additional variation in the readings of most sensors depending on the local operating conditions for the coin acceptor. Although the variation for these effects is not generally large, it would be large enough to seriously compromise the security of coin acceptance if acceptance windows for the coin signature data needed to accommodate variations from production unit to production unit.

TABLE 1
Canadian $2 Coin Signature Data For Model X-10

| Sensor Description | Value | Tolerance |
|---|---|---|
| First edge metal reading | 25 | 3 |
| Second edge metal reading | 34 | 2 |
| Center metal sensor reading | 41 | 2 |
| Diameter sensor reading | 91 | 7 |
| Temperature Reading | 68 | — |

In order for other coin acceptors to utilize the standard coin signature data for a coin which was produced by the standard coin acceptor unit for a particular model, it is necessary to produce a frame of reference for each production coin acceptor such that known calibration reference points within each frame of reference can be aligned with one another. The process of aligning one with the other requires a transformation in coordinates from one to the other based on points in each frame of reference known to represent the same coin. The preferred method of this invention utilizes two reference objects with divergent properties to identify two locations in each frame of reference. The reference objects are preferably a pair of specifically selected coins, tokens or specially made slugs which are passed through the coin acceptor for calibration. The objects may even be static targets used in some calibration process without passing them through the coin acceptor for calibration. The divergent reference objects chosen to calibrate the IDX X-10 coin acceptor's frame of reference are the 0.953″ diameter US Quarter and the standard 1.465″ diameter $1 casino token made of nickel silver alloy 752. As can readily be appreciated from the data of Table 2, these coins are fairly divergent in their sensed properties.

TABLE 2
Model X-10 Reference Coin Data

| Sensor Description | US $.25 | $1 Token |
|---|---|---|
| First edge metal reading | 54 | 30 |
| Second edge metal reading | 60 | 38 |
| Center metal sensor reading | 59 | 35 |
| Diameter sensor reading | 26 | 219 |
| Temperature Reading | 68 | 68 |

Once each coin acceptor has been calibrated with these same reference objects, the process of transforming values between one reference frame and the other requires specific linear algebra. To illustrate the process, Table 3 contains in its first column samples from the range for some physical property of the coin. Which physical property it is largely does not matter. However, in this illustration, data is acquired for both an ordinary production unit and the IDX standard reference unit for coins having each of the physical property sample points of column 1. For purposes of this description, the 30% and 70% physical value data points are defined as having been produced by the reference objects and thus are actually the reference points in the frame of reference for each of the coin acceptors.

TABLE 3
IIIustration Data For Transformation
Example

| | Production | Standard | |
|---|---|---|---|
| Physical | Unit | Unit | Transformed |
| Values | Values | Values | Values |
| 10% | 27 | 9 | 7 |
| 30% | 47 | 34 | 34 |
| 50% | 75 | 71 | 71 |
| 70% | 111 | 119 | 119 |
| 90% | 155 | 180 | 177 |

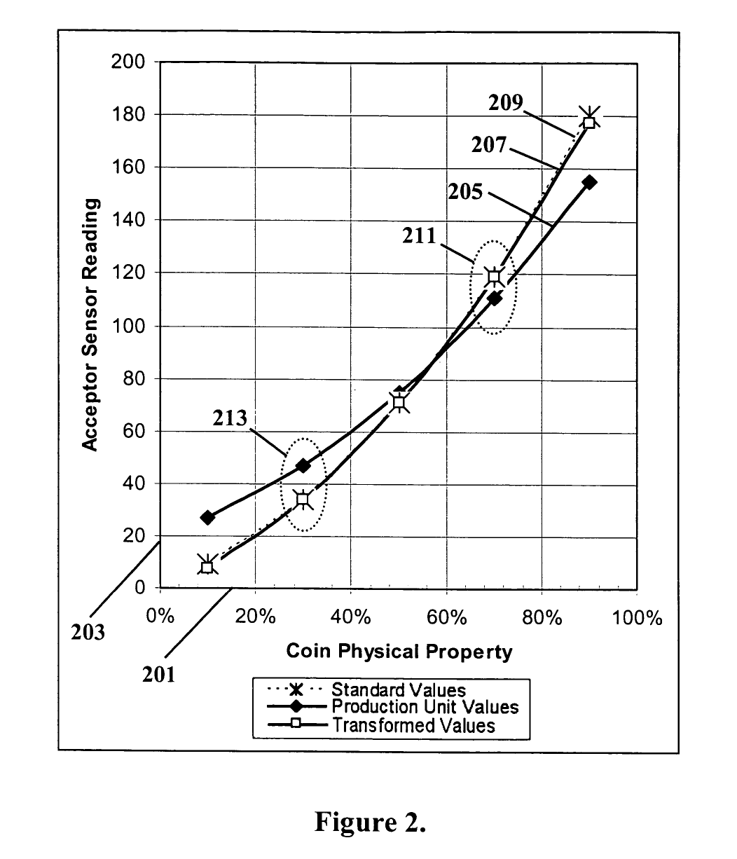

Table 3 is graphically represented in the graph of FIG. 2. Data points 213 are produced by the first reference object having 30% of a particular physical property and data points 211 are produced by a reference object having 70% of that same physical property. The curve 205 is the production unit starting values which are to be transformed into the frame of reference of the standard coin acceptor having data on curve 209. To do this the constants m and b must be found for use in the linear algebra transformation equation: x′=mx+b where m and b are the slope and offset coefficients, respectively, and x is any data point in one frame of reference while x′ is the data point in the other frame of reference. From linear algebra it is known that given two calibration reference points in each frame of reference then:
m=(x′₁−x′₂)/(x₁−x₂)=1.33
b=x′₁−mx₁=−28.4

Once m and b are known, the transformed values column of Table 3 may be calculated. As can readily be seen in Table 3, and its graphic counterpart FIG. 2, the transformed values, including intermediate values, for the production unit are nicely transformed to the reference frame of the standard coin acceptor.

Alternatively if one were to transform values from the reference frame of the standard coin acceptor to that of a particular production coin acceptor, the same equations are used, but the data elements are interchanged to produce the constants m and b for transformation in that direction. The values for m and b would then be 0.75 and 21.4 respectively. Of course, the reverse transformation may also be done by keeping the same values for m and b and using the inverse equation x=(x′−b)/m.

Similarly, if one were to directly transform values from the reference frame of any production coin acceptor to that of any other production coin acceptor, the same equations are used, but the reference object data for the end coin acceptor is substituted for that of the standard coin acceptor.

The preferred method of utilizing linear algebraic equations is a 1^{st} order mathematical transformation and is a choice of preference of precision and complexity of the transform among more complex polynomials transforms of n^{th} order (n>1) where n+1 reference objects are required for generating an n+1 term polynomial for reference frame transformation, or the more simple 0^{th} order where only a single reference object is required and only a simple fixed offset is used in the reference frame transformation.

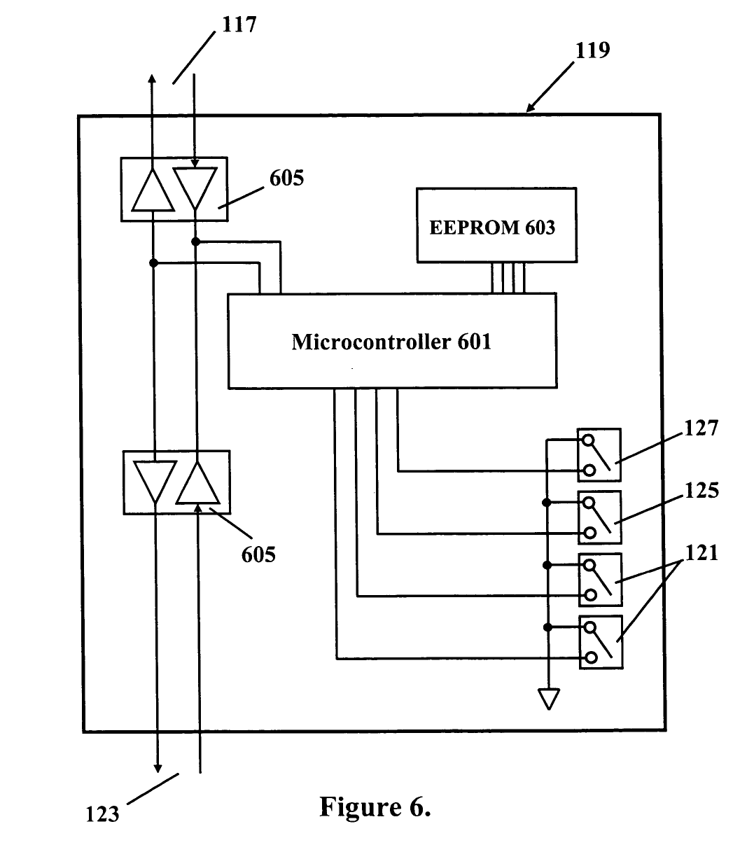

In the field, there are generally two established ways for programming the coin signature data into a coin acceptor. The predominant method used today is hand programming via passing multiple sample coins through the coin acceptor in a “learn mode” so that it may determine the average value and tolerance window for each portion of the coin signature. A second method involves connection of a coin signature transfer device 119 (FIG. 1 and FIG. 6) to a computer database via a connector 123 for download of standardized coin signature into the coin signature transfer device 119. A communication data port 110 of coin acceptor 101 is then connected through cable 117 to the coin signature transfer device 119. When a download button 121 is pressed, the coin signature transfer device 119 communicates with the coin acceptor 101 to download the appropriate coin signature data into the coin acceptor's active coin memory. Once programmed by either method the coin acceptor 101 uses the coin signature data to discriminate acceptable from non-acceptable coins.

The coin signature transfer device 119 could take the form of a custom designed device or could take the form of one of many conventional portable computing devices readily available on the market, such as a laptop or notebook computer, pocket PC, or personal digital assistant (PDA). In the preferred embodiment, the coin signature transfer device is a hand-held portable device containing a microcontroller 601, EEPROM 603, serial data communication port buffers 605, and buttons 121, 125, and 127. Microcontroller 601 can be a fairly basic device such as the Motorola MC68HC705C8 8-bit microcontroller containing RAM, ROM, CPU, UART, timer, I/O ports, and other functional blocks well known as component parts of microcontrollers. Although the coin signature data may be held in the RAM of the microcontroller 601, it is preferred that a nonvolatile memory such as EEPROM 603 be used to ensure the coin signature data is not at risk of loss should the battery or other power for the device fail. EEPROM 603 can be a device such as the serial interfaced Microchip 93LC46, or may in fact be integrated into alternative microcontroller choices. Buttons 121, 125, and 127 could be any one of many momentary contact push button switches readily available on the market. As shown, their connection requires the input pins of the microcontroller 601 to have an integrated pull up resistor. Serial data communication port buffers 605 provide voltage level and logic sense translation from that of the typical 5-volt microcontroller to that of the RS232 serial port specification and can be provided by the Maxim MAX232 or similar devices.

In accordance with the invention, the end purpose of determining the reference frame of each coin acceptor and determining the slope and offset coefficients m and b, respectively, for linear equations to transform one to another is to be able to perform the operation of copying the coin signature data from one production coin acceptor into to one or more other production coin acceptors in the field without the need to wait for the manufacturer to generate the standard coin signature data file for some new coin to be subsequently downloaded in the form of a standardized coin signature to the coin acceptors. Although it is possible that data communication ports from two coin acceptors could be directly connected for purpose of transferring the date from one coin acceptor to another, in the preferred embodiment of the invention, the data is passed through an intermediate coin signature transfer device 119. The coin signature transfer device 119 performs the tasks of, a) communicating to and from a coin acceptor, preferably over a serial data communications port with a protocol compatible with the coin acceptors for transferring coin signature data, b) storing and retrieving coin signature data as directed by external commands from either the serial data communications port or from a human directive, such as through pressing a button, and c) transforming coin signature data if not so done by the coin acceptors. For brevity, the aforementioned end purpose will be simply referenced as the “copy and clone” procedure.

In order to make the copy and clone procedure possible, each production coin acceptor must have its frame of reference calibrated by the same divergent pair of reference objects as part of its manufacturing process. Furthermore, any coin acceptor or coin signature transfer device that is to perform the reference frame transformation calculations must hold, or have access to, not only the coin signature data, but also the calibration reference point data of both the origin frame of reference and the destination frame of reference for the coin signature data.

As was earlier described, the coin signature transfer device 119 connects to the coin acceptor 101 via the data communications cable and connector 117. When a copy button 125 is pressed, the coin signature transfer device 119 sends a command to the coin acceptor 101 to return the coin signature data for one or more currently active coins in its coin signature memory. The coin acceptor 101 responds by transmitting the coin signature data back to the coin signature transfer device 119. When the coin signature data is received, its reference frame will have preferably already been transformed from that of this specific coin acceptor to that of the standard coin acceptor. Alternatively the transformation may be done in the coin signature transfer device 119 if the calibration reference point data for the coin acceptor is transmitted with the coin signature data so that the transformation calculations can be done there.

To complete the copy and clone procedure, the coin signature transfer device 119 is then connected to a second coin acceptor via the data communications cable. When a clone button 127 is pressed, the coin signature transfer device 119 sends the appropriate command and coin signature data to the second coin acceptor. Preferably, standardized coin signature data is held and transmitted from the coin signature transfer device 119 to the second coin acceptor which receives the data and performs the reference frame transformation from that of the standard coin acceptor to that of the second coin acceptor, then saves it to its active coin signature memory. Alternatively, the coin signature transfer device 118 may first request the second coin acceptor to send its reference object coin signatures such that the data transformation calculation may take place outside of the second coin acceptor, or the coin signature transfer device 119 may send the coin signature data in the reference frame of the first coin acceptor 101 along with its calibration reference point data for end-to-end transformation in a single step within the destination second coin acceptor.

Although metal sensor reading generally relate to the Q, or quality factor, associated with an L-C tank circuit based sensor, and diameter reading sensors generally relate to the ratio of two time spans for blocking and/or unblocking optical sensors, the data values within a coin signature really could be anything, so long as they usefully represent a range of some physical property of coins. These could additionally include, for example, optical surface color or pattern sensors, ultrasonic thickness sensors, capacitive thickness or size sensors, etc.

In addition to compensation for variation in components between production units, it is also important to compensate for temperature variation in components within the same production unit. It is generally possible to add circuit complexity to compensate for the effects temperature has on ferrites, ceramics, electro-optics and other electronic components. However, as implied, additional circuit complexity generally negatively impacts production cost. So, for example, while it may be possible to add components to make the metal sensor circuit sufficiently insensitive to temperature, or add separate temperature measurement components, it is often cheaper to characterize the manner in which the materials change the readings over temperature and compensate them in software.

Adding components to measure the temperature directly is fairly easy today with chips such as the MAX6576 by Maxim Integrated Products wherein the device produces pulses of width 10 T∥s, where T is the temperature in Kelvins. This simple 6-pin component requires no other external components to function and only a single pin on a microcontroller is required for monitoring and measuring the pulse width, and thus the temperature, reported by the chip.

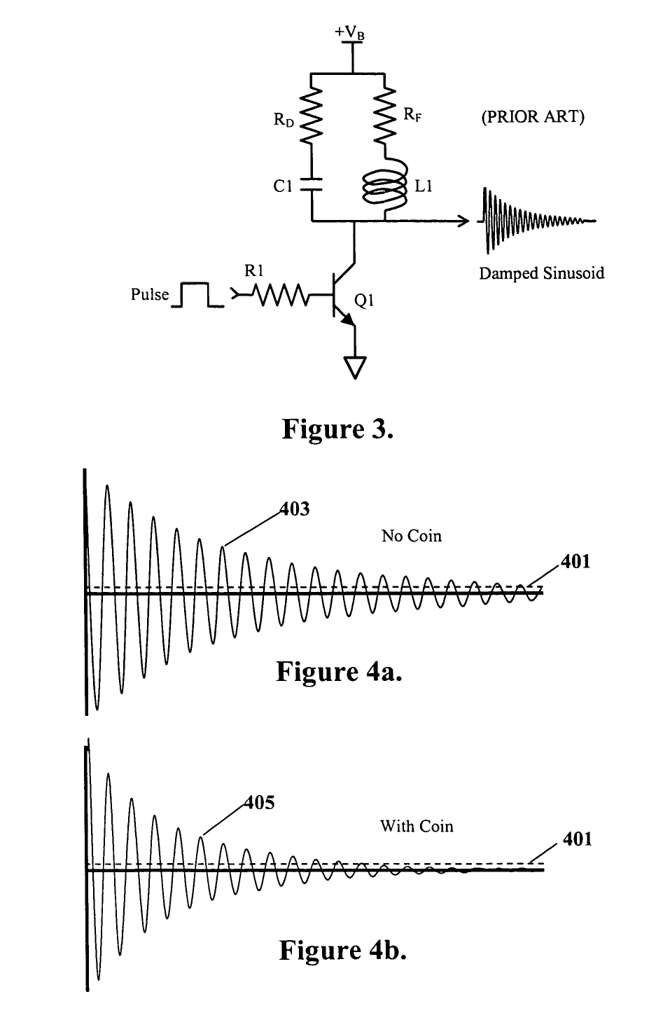

As an example of the lowest cost method of obtaining temperature information, consider the inductive metal sensor circuit of FIG. 3 which is well described in U.S. Pat. No. 5,273,151 granted on Dec. 28^{th}, 1993 to Carmen et al. A short activation pulse is input into R1 to turn on Q1 and impart energy to the resonant tank circuit formed by C1 and L1. When the pulse ends, the tank circuit produces a damped sinusoid voltage with a rate of damping determined by lossy parasitic resistive components within the resonant tank circuit, herein represented by R_{D} and R_{F}. R_{D} is representative of dielectric losses in capacitor C1 and R_{F} is representative of the ferrite losses and winding resistance within inductor L1 as is well described in the prior art. As shown in FIG. 4a, when no coin is present, the envelope of the damped sinusoid 403 eventually declines until the peaks of the waveform no longer surpass threshold 401. As the prior art describes, the sensor reading is simply the count of the number of cycles where the waveform surpasses the threshold and is obtained by electronically counting the pulses from a comparitor circuit connected to both the damped sinusoid 403 and threshold 401. When a coin is present in the magnetic field of the inductor L1, the magnetic field induces eddy currents to flow in the coin just as currents flow in the secondary windings of a transformer, and thus the resistance of the coin's alloy is magnetically coupled to the circuit causing additional damping as shown by damped sinusoid 405. The increase in damping results in a decreased number of cycles counted, thus forming a relationship between the count obtained and the alloy resistance properties of the coin.

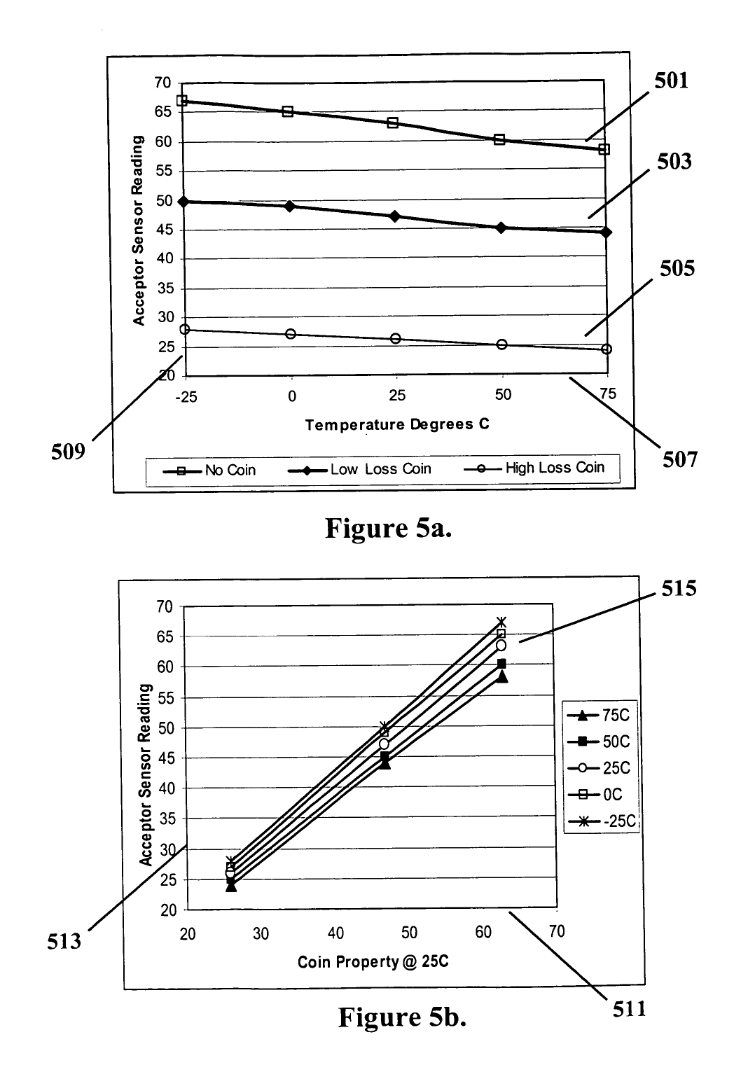

Likewise, it is well known that the lossy parasitic components of capacitor dielectrics, inductor ferrites, and coil windings will vary with temperature, and as they do, the total number of cycles where the damped sinusoid 403 surpasses threshold 401 will correspondingly change. FIG. 5a graphically shows the sensor response 509 of a circuit similar to that of FIG. 3 over a range of temperatures 507 and for the three following conditions of coin presence in the magnetic field of the inductive sensor; a) no coin present 501, b) a low loss type coin present 503, and c) a high loss type coin present 505. As can easily be appreciated, most of the time there is no coin present in the coin chute of a coin acceptor to affect its sensors. Thus the no coin present sensor reading data 501 is continually available except during the relatively infrequent moments when a coin actually is passing down the coin chute. As there is a one-to-one correspondence between the data points on the curves of 501, 503, and 505, the use of an arbitrarily chosen temperature scale 507 to tie them together is actually not necessary to retain their relationship. Thus the data points of the curve 501 may be used directly as the independent variable in the relationship as shown in the graph of FIG. 5b where the data points of the curve 501 become the horizontal axis and the data points 503 for the low loss coin, and data points 505 for the high loss coin are then plotted accordingly. As a result, FIG. 5b is equivalent to FIG. 5a, but with the data organized in the form of FIG. 2 such that one can more easily appreciate that the same principles used to transform coin signature data from the reference frame of one coin acceptor to that of another can also be used to transform coin signature data from one reference temperature frame in a con acceptor to another reference temperature frame in the same coin acceptor.

The effects of temperature can thereby be compensated with much the same kind of n^{th} order polynomial as formerly described for reference frame transformation. In essence there is established a reference frame at a first temperature and a reference frame at a second temperature. Thus, a horizontal axis 201 of FIG. 2 could represent the temperature while a vertical axis 203 might be the output of a particular sensor. Similarly, sufficient compensation is generally possible using only a first order polynomial. As implied, the temperature at the time other reference measurements are made is a part of the frame of reference. Thus when considering the entirety of a transformation from the reference frame of one coin acceptor to another, it will be required to know and account for the reference temperatures related to; a) the coin signature data, b) the calibration reference points for each of the coin acceptors, and c) possibly the calibration reference points for the standard coin acceptor.

The individual data in the coin signature that demonstrate temperature variation may be compensated according to an equation of the form x′=δT (ax+b) where δT is the difference in temperature between the present and the time when the reference coin values were recorded. Coefficients a and b respectively determine the linear and fixed offset compensation proportional to the temperature differential.

In the preferred embodiment, the temperature sensitive elements of the coin signature data are first temperature compensated to bring the data into the same reference frame as the calibration reference points for the coin acceptor so that the data correctly maps onto the stored reference frame of the coin acceptor which then can be related back to the reference frame of the standard coin acceptor through the reference frame transformation previously detailed. When the coin signature data is finally transformed into the frame of reference of the destination coin acceptor, it is then further compensated for temperature by the difference between the current operating temperature and the temperature at the time its calibration reference points were recorded. Having done so, the transformation from the current operating conditions and prerecorded reference frame of a first coin acceptor to the current operating conditions and prerecorded reference frame of a second coin acceptor is complete and the variations in components between production coin acceptors and the variation in operating temperature with each coin acceptor is compensated such that acceptance of the coins described by the coin signature can be done with a high acceptance of good coins while maintaining a relatively tight acceptance window for high security against acceptance of other types of coins or slugs.

While the choice of a first order polynomial compensation/transformation expression was chosen as optimum to meet the requirements in the preferred embodiment with the production model coin acceptors previously referenced, it is well understood that coin acceptors of other designs may necessitate an increase or decrease in the order of the polynomial to achieve the desired performance and is an execution detail in the practice of this invention.

Although a preferred embodiment of the invention has been specifically illustrated and claimed herein, it is to be understood that minor variations may be made in the apparatus without departing from the spirit and scope of the invention, as defined by the appended claims.

1. A method for transferring coin signature data from a first coin acceptor to a second coin acceptor comprising the steps of:
programming the first coin acceptor with coin signature data for the acceptance of at least one coin type;
connecting the data communication port of a coin signature transfer device to a data communication port of the first coin acceptor;
transforming the coin signature data from the reference frame of the first coin acceptor to standardized coin signature data in a predetermined standard reference frame;
transmitting the standardized coin signature data from the first coin acceptor to the coin signature transfer device;
connecting the data communication port of the coin signature transfer device to a data communication port of the second coin acceptor;
transmitting the standardized coin signature data from the coin signature transfer device to the second coin acceptor; and
transforming the coin signature data from the predetermined standard reference frame to the second coin acceptor's reference frame.

2. The method as defined in claim 1 wherein the transformation of coin signature data is performed by the first and second coin acceptors.

3. The method as defined in claim 1 wherein the transformation of coin signature data is performed by the coin signature transfer device.

4. The method of claim 1 where the step of transforming the coin signature data from the reference frame of the first coin acceptor to a predetermined standard reference frame includes:
producing calibration reference points for at least one measurement sensor, for at least one predetermined reference object, from both a preselected standard coin acceptor and from the first coin acceptor;
defining the reference frame of the first coin acceptor through computing an offset calibration factor substantially representative of the difference between the calibration reference points from the preselected standard coin acceptor and the first coin acceptor for each of the at least one measurement sensor; and
utilizing each the offset calibration factor to transform coin signature data from each of the at least one sensor from the reference frame of the first coin acceptor to the reference frame of the preselected standard coin acceptor.

5. The method of claim 2 where the step of transforming the coin signature data from the reference frame of the first coin acceptor to a predetermined standard reference frame includes:
producing calibration reference points for at least one measurement sensor, for at least one predetermined reference object, from both a preselected standard coin acceptor and from the first coin acceptor;
defining the reference frame of the first coin acceptor through computing an offset calibration factor substantially representative of the difference between the calibration reference points from the preselected standard coin acceptor and the first coin acceptor for each of the at least one measurement sensor; and
utilizing each the offset calibration factor to transform coin signature data from each of the at least one sensor from the reference frame of the first coin acceptor to the reference frame of the preselected standard coin acceptor.

6. The method of claim 3 where the step of transforming the coin signature data from the reference frame of the first coin acceptor to a predetermined standard reference frame includes:
producing calibration reference points for at least one measurement sensor, for at least one predetermined reference object, from both a preselected standard coin acceptor and from the first coin acceptor;
defining the reference frame of the first coin acceptor through computing an offset calibration factor substantially representative of the difference between the calibration reference points from the preselected standard coin acceptor and the first coin acceptor for each of the at least one measurement sensor; and
utilizing each the offset calibration factor to transform coin signature data from each of the at least one sensor from the reference frame of the first coin acceptor to the reference frame of the preselected standard coin acceptor.

7. The method as defined in claim 1 wherein the step of transforming the coin signature data from the reference frame of the first coin acceptor to a predetermined standard reference frame includes:
producing a set of calibration reference points for each of at least one measurement sensor, for at least two predetermined reference objects, from both a preselected standard coin acceptor and from the first coin acceptor;
defining the reference frame of the first coin acceptor through computing at least the offset and scale calibration factors substantially representative of the difference between the mathematical functions describing the set of calibration reference points from the preselected standard coin acceptor and the first coin acceptor; and
utilizing the offset and scale calibration factors to transform coin signature data from each of the at least one sensor from the reference frame of the first coin acceptor to the reference frame of the preselected standard coin acceptor.

8. The method as defined in claim 2 wherein the step of transforming the coin signature data from the reference frame of the first coin acceptor to a predetermined standard reference frame includes:
producing a set of calibration reference points for each of at least one measurement sensor, for at least two predetermined reference objects, from both a preselected standard coin acceptor and from the first coin acceptor;
defining the reference frame of the first coin acceptor through computing at least the offset and scale calibration factors substantially representative of the difference between the mathematical functions describing the set of calibration reference points from the preselected standard coin acceptor and the first coin acceptor; and
utilizing the offset and scale calibration factors to transform coin signature data from each of the at least one sensor from the reference frame of the first coin acceptor to the reference frame of the preselected standard coin acceptor.

9. The method as defined in claim 3 wherein the step of transforming the coin signature data from the reference frame of the first coin acceptor to a predetermined standard reference frame includes:
producing a set of calibration reference points for each of at least one measurement sensor, for at least two predetermined reference objects, from both a preselected standard coin acceptor and from the first coin acceptor;
defining the reference frame of the first coin acceptor through computing at least the offset and scale calibration factors substantially representative of the difference between the mathematical functions describing the set of calibration reference points from the preselected standard coin acceptor and the first coin acceptor; and
utilizing the offset and scale calibration factors to transform coin signature data from each of the at least one sensor from the reference frame of the first coin acceptor to the reference frame of the preselected standard coin acceptor.

10. The method as defined in claim 4 further including the steps of:
recording reference temperature information for the first coin acceptor at the time the reference frame of the first coin acceptor is determined;
determining the temperature difference between the reference temperature and the temperature at the time coin signatures data was recorded; and
using the temperature difference as an element in an algebraic expression to temperature compensate at least one of the coin signature data elements for alignment of the coin signature data with the reference frame of the first coin acceptor.

11. The method as defined in claim 7 further including the steps of:
recording reference temperature information for the first coin acceptor at the time the reference frame of the first coin acceptor is determined;
determining the temperature difference between the reference temperature and the temperature at the time coin signatures data was recorded; and
using the temperature difference as an element in an algebraic expression to temperature compensate at least one of the coin signature data elements for alignment of the coin signature data with the reference frame of the first coin acceptor.

12. A method of transforming coin signature data from a reference frame of a production coin acceptor to that of a predetermined standard reference frame comprising the steps of:
determining the predetermined standard reference frame through producing a set of calibration reference points for each of at least one measurement sensor, for at least two predetermined reference objects from a preselected standard coin acceptor;
determining the reference frame of the production coin acceptor through producing a set of calibration reference points for each of at least one measurement sensor, for at least two predetermined reference objects, from the production coin acceptor;
defining the reference frame of the production coin acceptor through computing at least the offset and scale calibration factors substantially representative of the difference between the mathematical functions describing the set of calibration reference points from the preselected standard coin acceptor and the production coin acceptor; and
utilizing the offset and scale calibration factors to transform coin signature data from each of the at least one sensor from the reference frame of the production coin acceptor to the reference frame of the preselected standard coin acceptor.

13. The method as defined in claim 12 including the steps of:
recording reference temperature information for the production coin acceptor at the time the reference frame of the production coin acceptor is determined;
determining the temperature difference between the reference temperature and the temperature at the time coin signatures data was recorded; and
using the temperature difference as an element in an algebraic expression to temperature compensate at least one of the coin signature data elements for alignment of the coin signature data with the reference frame of the production coin acceptor.

14. A method of transferring coin signature data from a first coin acceptor to a second coin acceptor comprising the steps of:
producing calibration reference points for at least one measurement sensor, for at least one predetermined reference object, from both the first and second coin acceptors and storing the calibration reference points in memory respectively therein;
programming the first coin acceptor with coin signature data for the acceptance of at least one coin type;
connecting the data communication port of a coin signature transfer device to a data communication port of the first coin acceptor; and
transmitting the coin signature data and the calibration reference points from the first coin acceptor to the coin signature transfer device;
connecting the data communication port of the coin signature transfer device to a data communication port of the second coin acceptor;
transmitting the coin signature data and the calibration reference points of the first coin acceptor from the coin signature transfer device to the second coin acceptor; and
utilizing the calibration reference points from both the first and second coin acceptors to transform the coin signature data from the first coin acceptor's reference frame to the second coin acceptor's reference frame.

15. A method for transferring coin signature data from a first coin acceptor to a second coin acceptor comprising the steps of:
producing calibration reference points for at least one measurement sensor, for at least one predetermined reference object, from both the first and second coin acceptors and storing the reference readings in memory respectively therein;
programming the first coin acceptor with coin signature data for the acceptance of at least one coin type;
connecting the data communication port of a coin signature transfer device to a data communication port of the first coin acceptor;
transmitting the coin signature data and the calibration reference points from the first coin acceptor to the coin signature transfer device;
connecting the data communication port of the coin signature transfer device to a data communication port of the second coin acceptor;
transmitting the calibration reference points from the second coin acceptor to the coin signature transfer device;
utilizing the calibration reference points from both first and second coin acceptors to transform the coin signature data from the first coin acceptor's reference frame to the second coin acceptor's reference frame; and
transmitting the transformed coin signature data from the coin signature transfer device to the second coin acceptor.
